(19) United States
(12) Patent Application Publication
(10) Pub. No.: US 2020/0173409 A1
(43) Pub. Date: Jun. 4, 2020

(54) DAMPER FOR A LIQUID LINE, IN PARTICULAR A FUEL LINE FOR AN INTERNAL COMBUSTION ENGINE

(71) Applicant: HUTCHINSON S.R.L., Rivoli (TO) (IT)

(72) Inventors: Stefano BENANTI, Torino (IT); Oliver TANNEAU, Saint Ouen (FR); Victor PILLON, Aucaleuc (FR)

(21) Appl. No.: 16/640,946

(22) PCT Filed: Aug. 20, 2018
(86) PCT No.: PCT/IB2018/056269

§ 371 Date: Feb. 21, 2020

(30) Foreign Application Priority Data
Aug. 22, 2017 (IT) 102017000095107

(51) Int. Cl. F02M 55/04; F16L 55/033

(52) U.S. Cl. CPC F02M 55/04; F16L 55/0338

(57) ABSTRACT

A damper is for a liquid line, in particular a fuel line for an internal combustion engine. The damper includes a housing having: a first body having an inlet for a liquid, a second body having an outlet for the liquid, and a tubular body interposed between the first body and the second body. The bodies are mounted together. A tubular membrane is located in the housing. Liquid is intended to flow from the inlet to the outlet passing through an internal side of the membrane. The membrane has two annular edges at its longitudinal ends, wherein the edges are inserted into two respective recesses. A first recess is provided by the tubular body and the first body, and a second recess is provided by the tubular body and the second body, so that the bodies of the housing are sealingly mounted.

### TECHNICAL FIELD

The present invention relates to a damper for a liquid line, in particular a fuel line for an internal combustion engine. The damper serves to damp the pulsating fluid flow in the liquid line, reducing the pressure fluctuations of the liquid.

### BACKGROUND ART

The damper serves to damp the pulsating liquid flow in the liquid line, reducing the pressure fluctuations of the liquid. This allows to reduce the noise created by the flow of the liquid in the line. Such dampers are conveniently used in the fuel lines for internal combustion engines.

U.S. Pat. No. 3,878,867 describes a particular type of these dampers. The membrane, by vibrating in response to the fluid flow, reduces the peak of pressure fluctuation of the fluid, in order to also reduce the noise generated by the fluid. This aspect is advantageous in a fuel line for an internal combustion engine such as motor vehicle.

However, such devices suffer from a few drawbacks.

One drawback is that the devices known in the art have a complex construction and include many components.

A further drawback is that it is complicated to assemble and disassemble such dampers, and the operation takes a long time.

### SUMMARY OF THE INVENTION

It is one object of the present invention to provide a damper for a liquid line, which in particular can solve these and other problems of the prior art while being simple and economical to manufacture.

A further object is to provide a damper for a fluid line which is easy and quick to assemble.

According to the present invention, these and other objects are achieved through a damper for a liquid line which incorporates the technical features set out in the appended independent claim.

It is to be understood that the appended claims are an integral part of the technical teachings provided in the following detailed description of the invention. In particular, the appended dependent claims define some preferred embodiments of the present invention, which include some optional technical features.

### BRIEF DESCRIPTION OF THE DRAWINGS

Further features and advantages of the present invention will become apparent from the following detailed description, which is supplied by way of non-limiting example with particular reference to the annexed drawings, wherein:

FIG. 1 is a perspective view according to one embodiment of the present invention;

FIG. 2 is a section view of the device of FIG. 1 along the longitudinal axis thereof;

FIGS. 3, 4 are cross-sections perpendicular to the longitudinal axis of the device of FIG. 1.

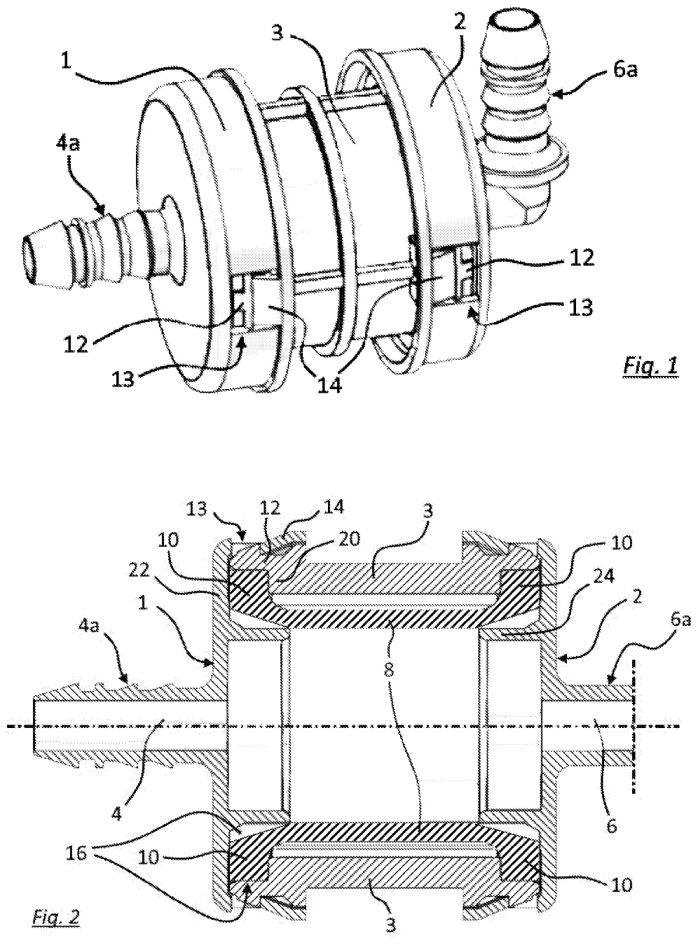

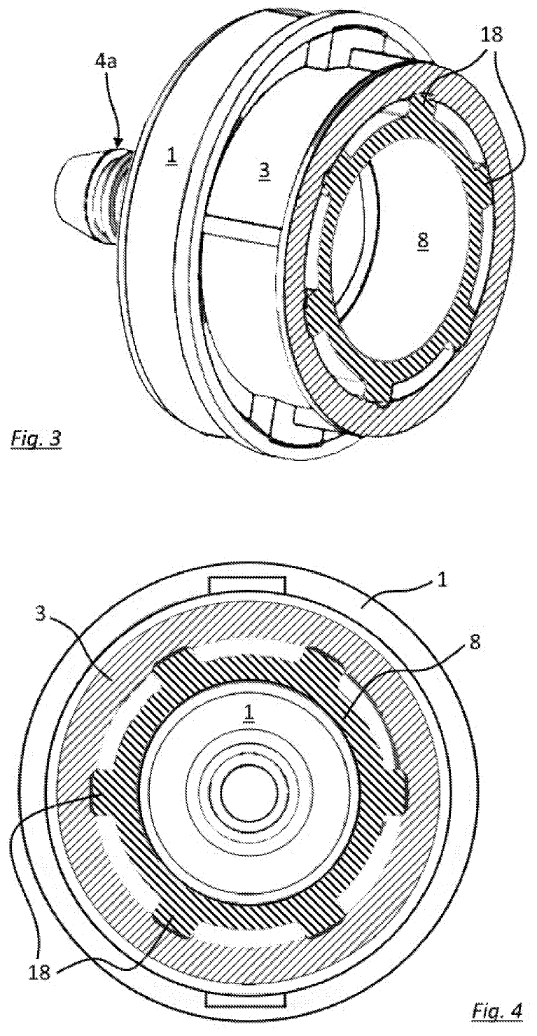

### DETAILED DESCRIPTION OF THE INVENTION

With particular reference to the drawings, the invention concerns a damper for a liquid line, in particular a fuel line for an internal combustion engine, comprising:
a housing comprising: a first body 1 having an inlet 4 for a liquid, a second body 2 having an outlet 6 for the liquid, and a tubular body 3 interposed between the first body 1 and the second body 2; said bodies 1, 2, 3 being mounted together;
a tubular membrane 8 located in the housing, wherein the liquid is intended to flow from the inlet 4 to the outlet 6 passing through an internal side of the membrane 8.

The membrane 8 has two annular edges 10 at its longitudinal ends, wherein said edges 10 are inserted into two respective recesses 16. A first recess 16 is provided by the tubular body 3 and the first body 1, and a second recess 16 is provided by the tubular body 3 and the second body 2, so that the bodies 1, 2, 3 of the housing 2 are sealingly mounted. In particular, the edges 10 are circular. The first and the second body 1, 2 face the external side of the damper.

The liquid enters from the inlet 4 into the membrane 8, and then exits from the outlet 6. Due to the passage of the fluid, the membrane 8 vibrates so as to reduce the pressure fluctuations of the liquid, thus dampening the noise generated by the liquid flow. Therefore, the damper is easy and cheap to produce, and it has a reduced number of components, while being efficient and reliable.

Preferably, the tubular body 3 is mounted to the first body 1 and to the second body 2 by a quick release system. In particular, the quick release system is a snap system. Preferably, the first and the second body 1, 2, and/or the tubular body 3, have deformable portions configured to mutually engage. The user, acting on these deformable portions, can disassemble the bodies 1, 2, 3. In the example, there is a clip system. In particular, the tubular body 3 comprises engagement members 12 configured to be inserted into mounting recesses 13, in the example apertures, provided in the first and second body 1, 2. The engagement members 12 are configured to engage with the mounting recesses 13. The engagement member 12 has a shape so as not to be unintentionally released from the mounting recess 13. In particular, the first and second body 1, 2 have deformable elements 14, in particular fins, facing the mounting recesses 13 and configured for engaging with the engagement members 12. Therefore, it is easy and quick to mount the bodies 1, 2, 3 together. Indeed, the user has simply to bring the bodies 1, 2, 3 near and press them together in order to cause the mechanism to snap. A further advantage of the invention is that the pressure generated by the liquid does not create further mechanical stress on the quick release system, since such pressure mainly acts on the membrane 8 in the radial direction, while the quick release system works in the axial direction. According to alternative embodiments, the quick release system includes a bayonet system, or a latch system, arranged between the tubular body 3 and the first and the second body 1, 2. According to an alternative embodiment, the tubular body 3 is welded to the first and to the second body 1, 2. This welding may be carried out according to several per se known methods.

The edge 10 is pressed inside the recess 16, when the housing is mounted, thus ensuring a water tight sealing. Preferably, each edge 10 comprises an enlarged portion inserted in the respective recess 16. The enlarged portion has a greater thickness compared to an adjacent portion of the membrane 8 connected to it 10. The enlarged portion provides a better water tight sealing. Furthermore, the stresses due to its compression mainly act in the radial direction, thus reducing the force acting on the quick release system, which mainly acts in the axial direction. This increases the durability and the reliability of the damper.

In the preferred embodiment, the internal side of the membrane 8 is smooth (i.e. there are no internal ridges, or the membrane 8 is not accordion-shaped), and an external side of the membrane 8 comprises ridges 18. The internal side of the membrane 8 is annular. The damper is conveniently suited to working with high-pressure liquid, in particular from 5 to 8 bar, while having a low friction between the liquid and the membrane 8. In particular, the ridges 18 are substantially parallel to a longitudinal axis of the membrane 8. Conveniently, the ridges 18 are equally spaced around the membrane 8. Preferably, the ridges 18 are in contact with the tubular body 3 when there is no liquid flowing inside the membrane 8. So, when the liquid in pressure flows in the membrane 8, the ridges 18 rest against the tubular body 3, and the portion of membrane 8 connecting two adjacent ridges 18 can deform under the liquid pressure. This ensures a good damping with high-pressure liquid, in particular from 5 to 8 bar.

In the particular embodiment shown, with reference to a cross-section of the membrane 8, the membrane 8 has a greater thickness in correspondence of the ridges 18. In the remaining parts of the membrane 8, the thickness thereof 8 is smaller.

Conveniently, within the internal side of the membrane 8 there are no other elements or abutting portions. Only the fluid is intended to flow being in contact with the internal side of the membrane 8.

In the example shown, an external side of the membrane 8 and the tubular body 3 define a peripheral chamber. The membrane 8 separates the fluid flowing inside it 8 from the peripheral chamber in a fluid tight manner. Preferably, the peripheral chamber is sealed. Between the membrane 8 and the tubular body 3 there is a space, that is conveniently filled with air, preferably at atmospheric pressure. In alternative, the external side of the membrane 8 and the tubular body 3 define a peripheral chamber that can be connected with the exterior of the damper, for instance by an opening or a valve.

Preferably, the housing and the membrane 8 are made of polymeric material. The bodies 1, 2, 3 can be made of plastic material, or of composite material such as fiber reinforced polymers (FRP). Conveniently, the bodies 1, 2, 3 comprise a different material than the membrane 8. In facts, the membrane 8 is preferably made of rubber or of a material with similar properties.

Optionally, the bodies 1, 2, 3 are made of composite material comprising a plastic matrix (preferably a polymer, such as a thermoplastic polymer), and glass fiber as reinforcement. Even the carbon black can be used as filler, in addition or in alternative to the glass fiber. According to a possible embodiment, the glass fiber in the bodies 1, 2, 3 is 20%-50%, more preferably about 40%. For example, suitable materials for the membrane 8 are

EPDM, HNBR, FKM. For example, suitable materials for the bodies 1, 2, 3 are polyamide, polyphthalamide, PEEK, polyurethane, polyphenilsulphone, ABS, polyacetals. Preferably, the bodies 1, 2, 3 are manufactured by injection moulding.

The damper can conveniently be employed in a fuel feed or return line for an internal combustion engine, in particular for a motor vehicle such as a car. The fuel line is preferably a gasoline or diesel fuel line configured for cooperating with a gasoline or diesel engine respectively. The liquid line is conveniently connected to a fluid pressure system. In particular, the fuel line is part of a fuel injection system. The damper can also be conveniently employed in a cooling circuit for an engine, such as an internal combustion engine, in particular for a motor vehicle; for example, the damper can be applied in a feed or return duct for a coolant fluid or liquid.

In the preferred embodiment, the cross-section of the membrane 8 is circular, in particular the internal side thereof. Preferably, the tubular body 3 is circular in cross-section.

In particular, the inlet 4 and the outlet 6 are comprised in two ducts (an inlet duct 4a and an outlet duct 6a, respectively). In particular, the first portions of ducts 4a and 6a facing the interior of the damper are straight, preferably aligned on a same plane, and more preferably aligned on a same straight line. In the preferred example, the straight line connecting the axes of the first portions of the ducts 4a and 6a coincides with the longitudinal axis of the tubular membrane 8. Therefore, the damper causes advantageously low load losses in the fluid when in use. In particular, the outlet duct 6a has a bent portion inclined (in particular, by 90°) with respect to its first portion. According to further embodiments, there can be a plurality of inlets 4 and/or outlets 6. It is also possible to locate the ducts 4a and 6a in a different manner in the space. In particular, the ducts 4a and 6a are integral with the first body 1 and, respectively, the second body 2, and allow to connect the damper with the liquid line. Optionally, sealing means, such as a gasket (for example an 0-ring), ensure the watertight sealing between the damper and the pipes of the liquid line. According to possible embodiments, the ducts 4a and 6a can be in the form of different possible fittings, such as male or female SAE, fir-tree fitting (as in the shown example), rubber interfaces, etc. Furthermore, the fittings can be mutually oriented in the space in any manner (e.g., 90°, 135°, 180°). The fitting system is modular; hence, by changing only some components, it is possible to obtain any desired combination, for example with diameters, orientations, and interfaces that are different on the two sides of the ducts 4a and 6a. For example, it is possible to change the first body 1 and/or the second body 2, while keeping the same tubular body 3 and the membrane 8, in order to change the form of the ducts 4a and 6a so as to adapt the connection to the desired liquid line.

The edge 10 is conveniently pressed between the tubular body 3 and the first body 1 at least along a direction parallel to the longitudinal axis of the membrane (horizontal dash-dot line of FIG. 2). In particular, the edge 10 is pressed by a transversal shoulder 20 of the tubular body 3 and a transversal wall 22 of the first body 1. In particular, a radially external side of the edge 10 faces, or is in contact with, a longitudinal wall 23 of the tubular body 3; in FIG. 2, the longitudinal wall 23 is an internal side of the engagement member 12. A radially internal side of the edge 10 faces, or is in contact with, a longitudinal wall 24 of the first body 1. The same applies symmetrically to the second body 2. The elements 20, 22, 23, 24 have an annular development so as to surround the annular edges 10; in other words, elements 20, 22, 23, 24 are substantially rims. Therefore, the membrane 8 is mechanically kept in the correct position within the housing but without causing excessive stress on the membrane 8, and ensuring a water tight sealing. Also, the membrane 8 does not slip away under pressure. The damper is thus reliable.

It is also part of the invention the use of the damper for damping vibrations in a fuel line for an internal combustion engine, in particular when the fuel pressure ranges from 5 to 8 bar.

Of course, without prejudice to the principle of the invention, the forms of embodiment and the implementation details may be extensively varied from those described and illustrated herein by way of non-limiting example, without however departing from the scope of the invention as set out in the appended claims.

1. A damper for a liquid line for an internal combustion engine, comprising:
a housing comprising: a first body having an inlet for a liquid, a second body having an outlet for the liquid, and a tubular body interposed between the first body and the second body; said first body and said second body being mounted together;
a tubular membrane located in the housing, wherein the liquid flows from the inlet to the outlet passing through an internal side of the membrane;
the membrane has two annular edges at its longitudinal ends, wherein said edges are inserted into two respective recesses;
wherein a first recess is provided by the tubular body and the first body, and a second recess is provided by the tubular body and the second body, so that the first body and the second body of the housing are sealingly mounted;
wherein the internal side of the membrane is smooth, and an external side of the membrane comprises ridges.

2. The damper according to claim 1, wherein the tubular body is mounted to the first body and to the second body by a quick release system.

3. The damper according to claim 2, wherein the quick release system is a snap system.

4. The damper according to claim 3, wherein the tubular body comprises engagement members configured to be inserted into mounting recesses provided in the first body and the second body, so as to mount the tubular body to the first body and to the second body.

5. The damper according to claim 4, wherein the first body and the second body have deformable elements facing the mounting recesses and configured for engaging with the engagement members.

6. The damper according to claim 1, wherein each edge comprises an enlarged portion inserted in the respective recess.

7. The damper according to claim 1, wherein the internal side of the membrane is free of internal ridges, or the membrane comprises a non-accordion shape.

8. The damper according to claim 1, wherein the ridges are substantially parallel to a longitudinal axis of the membrane.

9. The damper according to claim 1, wherein the ridges are in contact with the tubular body when no liquid flows inside the membrane.

10. Damper The damper according to claim 1, wherein an external side of the membrane and the tubular body define a sealed peripheral chamber.

11. The damper according to claim 1, wherein the edges are pressed between the tubular body and the first body, and respectively the second body, at least along a direction parallel to a longitudinal axis of the membrane.

12. The damper according to claim 1, wherein, with reference to a cross-section of the membrane, the membrane has a greater thickness in correspondence of the ridges.

13. The damper according to claim 10, wherein the sealed peripheral chamber is filled with air at atmospheric pressure.

14. The damper according to claim 1, wherein the internal side of the membrane is annular or circular.

15. A fuel line for an internal combustion engine comprising a damper according to claim 1.

16. (canceled)
